(19) United States
(12) Patent Application Publication
(10) Pub. No.: US 2016/0354677 A1
(43) Pub. Date: Dec. 8, 2016

(54) BLACKJACK GAME TOURNAMENT AND SYSTEM

(71) Applicant: Mark H. Jones, Gardnerville, NV (US)

(72) Inventor: Mark H. Jones, Gardnerville, NV (US)

(21) Appl. No.: 15/224,153

(22) Filed: Jul. 29, 2016

Related U.S. Application Data
(63) Continuation-in-part of application No. 15/172,316, filed on Jun. 3, 2016.
(60) Provisional application No. 62/170,485, filed on Jun. 3, 2015.

(51) Int. Cl. A63F 1/00; G07F 17/32

(52) U.S. Cl. CPC A63F 1/00; G07F 17/3293; G07F 17/3276; G07F 17/3248; A63F 2001/003

(57) ABSTRACT

Methods of playing a blackjack game and tournament are provided. The methods include providing plurality of playing cards which include at least one wild card. In the event that a player draws the at least one wild card, either a value equal to the primary wager of the drawing player may be awarded, or the wager of another player separate from the drawing player may be forfeited. In the event that a dealer draws the wild card, each of the players are designated a winner and are awarded a value equal to their wager.

### CROSS-REFERENCE TO RELATED APPLICATIONS

The present application is a continuation-in-part of U.S. patent application Ser. No. 15/172,316, filed Jun. 3, 2016 and entitled “Method of Playing a Blackjack Game”, which claims priority to U.S. Provisional Patent Application Ser. No. 62/170,485, filed on Jun. 3, 2015, and entitled “SYSTEM FOR PLAYING A BLACKJACK GAME”, the disclosures of which are hereby incorporated by reference as though set forth fully herein.

### TECHNICAL FIELD

The present disclosure relates generally to a method of playing a game of chance, and more particularly, toward a method of playing a blackjack tournament.

### BACKGROUND OF THE DISCLOSURE

Games of chance, like blackjack, are well-known activities whose outcomes are strongly influenced by randomizing devices and upon which contestants may wager money as they forecast outcomes. Games of chance have been played throughout all of human history in various forms, and are considered popular pastimes by many. It is also known for games of chance to be played in tournament form, in which one or more winners are determined from a field of players. Players of games of chance are attracted to new and exciting methods of game play. Therefore, there remains a need for new and interesting systems for playing games of chance that maintain player interest and attract new players.

### SUMMARY OF THE DISCLOSURE

It is therefore an aspect of the disclosure, to provide a method of playing a blackjack tournament that provides increased excitement and competition among the players of the game.

According to another aspect of the present disclosure, a method of playing a blackjack tournament that yields increased excitement and competition among the players of the tournament is provided.

According to these and the other aspects of the disclosure, a method of playing a blackjack tournament that includes a plurality of players and a dealer is provided. The method includes playing a plurality of rounds of a blackjack game, with each round of the blackjack game utilizing a collection of playing cards consisting of at least one deck of standard playing cards, each having a numerical value and a suit and a color, and at least one wild card. A playing surface is provided that includes a plurality of player positions and at least one dealer position. A primary wager area is associated on the playing surface with each player position for receipt of player wagers. Each round of blackjack proceeds with players making decisions as to whether or not to draw additional cards. Similarly, the dealer can draw additional cards according to preset rules. Player wagers are resolved in accordance with normal rules for blackjack. In the event that the wild card is drawn by a player, either a value equal to the amount of the primary wager that player is awarded, or the primary wager of another player separate from the drawing player is forfeited based on a selection by the user who drew the wild card. If at least one wild card is drawn to the dealer, all player hands are deemed winners and the amount of their primary wagers are paid out. The tournament continues for a preset number of rounds until a winning player is identified as the player with the greatest amount of chips.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a top view of an exemplary playing surface that can be used with a method of playing a blackjack game in accordance with an aspect of the present disclosure; and

FIG. 2 is a flow diagram presenting a method of playing a blackjack tournament game according to an aspect of the present disclosure.

### DETAILED DESCRIPTION OF THE DISCLOSURE

Referring to the Figures, wherein like numerals indicate corresponding parts throughout the several views, a system of playing a blackjack tournament and game is generally shown. The blackjack game includes at least one dealer and a plurality of players generally disposed about a playing surface. The players compete against one another in various stages of the tournament and advance based on how many chips they have at the completion of each stage. It should be appreciated that any numbers of stages, or rounds within each stage, could be utilized in the tournament.

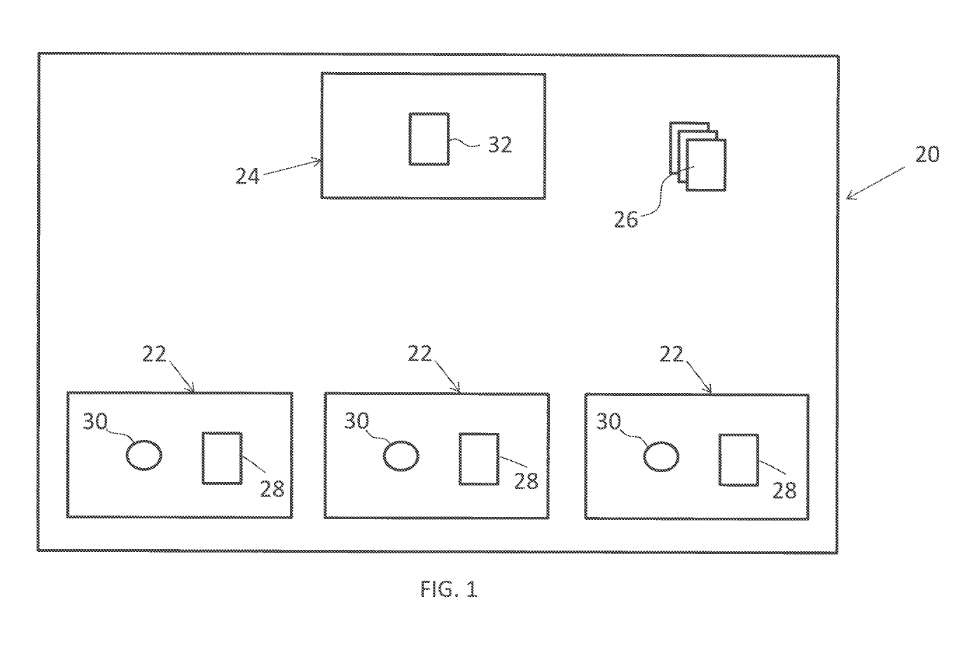

FIG. 1 presents an exemplary embodiment of a playing surface 20 on which a game of the disclosed blackjack tournament system may be played. Any number of such playing surfaces 20 may be utilized. According to an aspect, the playing surface 20 may present a plurality of player positions 22 and one dealer position 24. It should be appreciated that the playing surface 20 may be configured to include any number of player positions 22 to allow any number of players to participate in the game. The player positions 22 may be represented in a variety of different ways.

The playing surface 20 may be configured to receive a plurality of playing cards 26, which can be utilized with the disclosed method and system. According to an aspect, each player position 22 of the playing surface 20 can present a player card indicia 28 for receiving playing cards 26 as well as a player wager indicia 30 for receiving chips or other forms of currency from the player in the form of a wager on the game outcome. Furthermore, the dealer position 24 may include a dealer card indicia 32 for receiving playing cards 26 for the dealer.

Each game of the tournament may be played in a tangible application or in an electronic gaming environment, whereby the playing surface 20 may be presented on one or more display screens of computer implemented devices. This may be configured as electronic gaming machines like video poker machines found in regulated gaming establishments, personal computers, hand-held devices running software from the internal memory or the internet, or by other suitable methods, including any combination of the above. For example, the system may be configured as a combination of a physical playing surface(s) 20 together with an electronic gaming environment. According to an aspect, in an electronic or virtual environment, the playing cards 26 may be displayed as images of playing cards 26 on the display screen, whereas in a tangible application, the playing cards 26 may comprise physical playing cards 26 which are handled by players in physically.

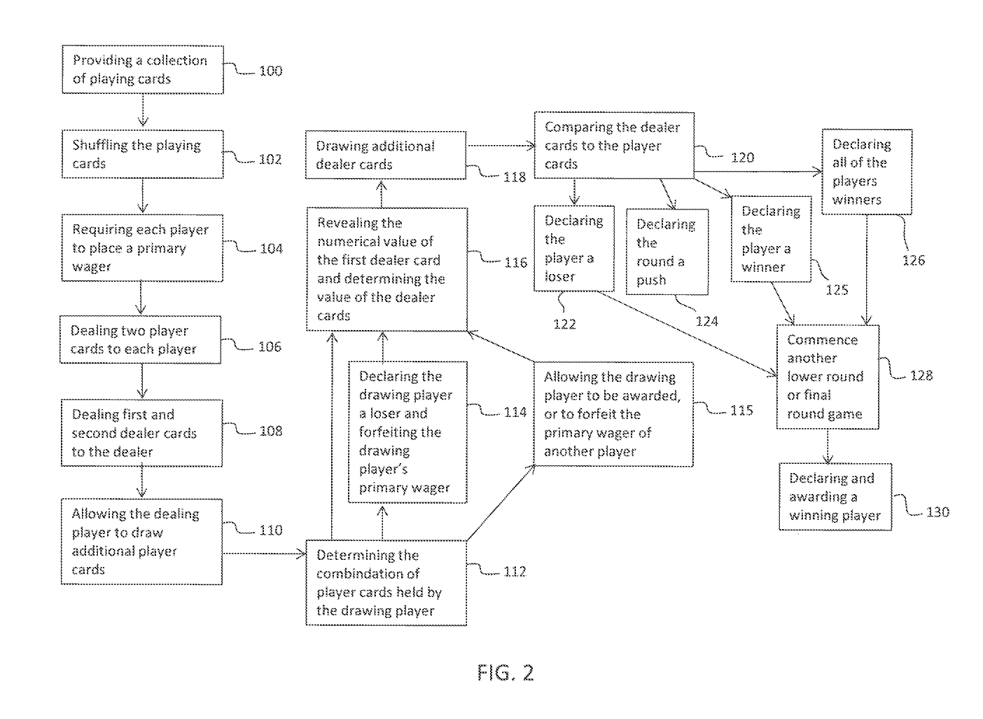

As best shown in FIG. 2, the system can include a method of playing the blackjack tournament. A plurality of lower round games of the tournament may be played first. Each lower round game may start with 100 providing a collection of playing cards 26 that consists of at least one standard deck of playing cards 26. Each of the playing cards 26 may have a numerical value, a suit and a color. As is known in the art, each “face card” and “ace” of the playing cards 26 may have a predetermined numerical value associated therewith. It should be appreciated that any number of decks of playing cards 26 could be used and other types of playing cards 26 could be utilized without departing from the scope of the subject disclosure. The collection of playing cards 26 further can include a predetermined number of wild, or “crazy cards”. In the exemplary embodiment, one crazy card may be provided for each deck of cards; however, more crazy cards could be utilized without departing from the scope of the subject disclosure. Furthermore, in the exemplary embodiment, the crazy card may be a joker; however, other designs could be utilized without departing from the scope of the subject disclosure.

The method may proceed by 102 shuffling the collection of playing cards 26 to position the playing cards 26 in a random order. After the playing cards 26 are shuffled, the method may continue by 104 requiring each player to place a primary wager on their player wager indicia 30. Casino chips, or other markers, may be utilized to represent the primary wager. The chips or other markers may each represent a monetary value. It will also be appreciated that other wager areas may be employed to represent other bets.

After each player has placed his/her primary wager, the method may continue by 106 dealing two player cards from the collection of playing cards 26 to each player in a manner so as to reveal the value of the player cards. In the exemplary embodiment, the player cards are placed over the player card indicia 28, however, they could be placed at other locations. After or while the player cards are dealt, the method may include 108 dealing a first dealer card and a second dealer card to the dealer in a manner so as to conceal the value of the first dealer card and reveal the value of the second dealer card. In the exemplary embodiment, the dealer cards are placed over the dealer card indicia 32, however, they could be placed at other locations.

After the initial player and dealer cards have been dealt, the method may continue with 110 separately designating each player a drawing player and allowing each drawing player to request additional player cards from the collection of playing cards 26 until one of several outcomes have been reached. The outcomes may include the player achieving a numerical value of player cards over a predetermined maximum value, such as twenty one, the player achieves a desired numerical value of player cards that is less than or equal to a value of twenty one, or the drawing of a crazy card. During or after the drawing of the player cards, the method may include 112 determining the combination of player cards held by the drawing player.

If the numerical value of the player cards is greater than a value of twenty one, then the method may proceed by 114 declaring the drawing player a loser and forfeiting the primary wager of the drawing player. If the drawing player is declared a loser, a next player is declared a drawing player and draws player cards in the same fashion as described above. If at any point the numerical value of the player cards is at a desirable value of less than or equal to twenty one, then the player may stand and a next player may be declared the drawing player. If the drawing player draws a crazy card, the method may proceed by 115 allowing the drawing player to either be immediately awarded a value equal to their primary wager, or to allow the player to forfeit the primary wager of another player. If the drawing player elects to forfeit the primary wager of another player, the crazy card is then discarded and replaced with another card and the drawing player may then continue drawing player cards as desired. It should be appreciated that allowing the drawing player to forfeit the wager of another player according that the drawing player choosing increases the excitement of the tournament by providing an additional competitive aspect to the game. More specifically, since a player's primary wager may be forfeited by another player at any given time, players may consider not placing as high of a wager as they would otherwise place.

The method may continue with 116 revealing the numerical value of the first dealer card and determining the combined numerical value of the first and second dealer cards. If the combined numerical value of the first and second dealer cards is less than twenty one, then the method may proceed by 118 drawing additional dealer cards from the collection of playing cards 26 for the dealer until the numerical value of the dealer cards is less than or equal to twenty one, and greater than the total numerical value of the player cards of each of the players, until the numerical value of the dealer cards exceeds twenty one, or until the dealer draws a crazy card.

During or after the drawing of the dealer cards, the method includes 120 comparing the combination of the dealer cards to the combination of player cards. If the numerical value of the dealer cards is less than or equal to twenty one, and greater than the total numerical value of the player cards of any given player, then the method may continue by 122 declaring that player a loser and forfeiting that player's primary wager. On the other hand, if the numerical value of the dealer cards is equal to the numerical value of the player cards of any given player, then the methods may continue by 124 declaring the round a push for that player and awarding no prize to the player nor forfeiting the primary wager of the player. Alternatively, if the numerical value of the player cards of any given player is less than or equal to twenty one, and greater than the total numerical value of the dealer cards, then the method may proceed by 125 declaring the player a winner and awarding a value equal to the primary wager of the player to the player. If at any point the dealer draws a crazy card, the method may proceed by 126 declaring all of the players winners and awarding each of the players a value equal to their primary wagers.

After the dealer has finished drawings cards and it has been determined whether each of the players has pushed or is deemed a winner or loser, the round terminates and the method may proceed by 128 commencing another lower round game or a final round game. In the exemplary embodiment, a final round game commences after thirteen lower round games have been completed, however, the final round game could commence after any other number of lower round games have been played without departing from the scope of the subject disclosure.

The final round game may follow the same previously described steps as the lower round games except a secret wager may be placed instead of the primary wager. More specifically, the secret wager may be placed in a manner so as to conceal the value of the secret wager. In the exemplary embodiment, the secret wager may be placed by giving each player a pen and paper and allowing the players to write down the secret wager, however, it should be appreciated that other methods could be utilized to provide the secret wager, e.g., the secret wager could be submitted electronically such as on a terminal associated with the playing surface or via a player's mobile device, without departing from the scope of the subject disclosure. Once all of the players have determined and noted their secret wagers, the secret wagers may be revealed and each player may be required to place a number of chips equal to their respective secret wager amount on the playing surface. It should be appreciated that requiring the players to place a secret wager in the final round provides for increased excitement since players are forced to consider what other players are secretly wagering in determining the amount of their own secret wager. This may be a large consideration when only the players with the highest numbers of chips advance to additional stages of the tournament. It should further be appreciated that the secret wager could be utilized in other rounds of the tournament.

After the final round commences, the method may proceed by 130 declaring the player who has the most chips a winning player. The winning player may awarded by being advanced to the next stage of the tournament and/or by being awarded a monetary value equal to the numbers of chips that they held at the commencement of the final round. Other awards could be provided such as an award that correlates with the number of places paid in the tournament. It should be appreciated that additional rounds could be played after the final round and any number of stages could be played in the tournament, each encompassed within or outside of the scope of the previously described system.

Note that not all of the activities described above in the general description or the examples are required, that a portion of a specific activity may not be required, and that one or more further activities may be performed in addition to those described. Still further, the orders in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method of playing a blackjack game including a plurality of players and a dealer, said method comprising:
providing a collection of playing cards consisting of at least one deck of playing cards each having a numerical value, a suit and a color, and wherein the collection of playing cards further includes at least one wild card;
providing a playing surface including a plurality of player positions wherein each of the player positions may receive a plurality of the cards, and at least one dealer position at which a plurality of the cards may be received for the dealer;
requiring each player to place a primary wager;
dealing two player cards to each player from the collection of playing cards in a manner so as to reveal the value of the player cards;
dealing a first dealer card and a second dealer card to the dealer in a manner so as to conceal the value of the first dealer card and reveal the value of the second dealer card;
separately allowing each player to request additional player cards from the collection of playing cards until the player achieves a desired numerical value of player cards less than or equal to a predetermined maximum value or until the player draws the at least one wild card;
declaring the player a loser if the numerical value of the player cards is greater than the predetermined maximum value with the wager being lost by the player;
revealing the value of the first dealer card;
drawing additional dealer cards from the collection of playing cards for the dealer until the numerical value of the dealer cards is less than or equal to the predetermined maximum value and greater than the total numerical value of the player cards of each of the players, or until the numerical value of the dealer cards exceeds the predetermined maximum value, or until he dealer draws the at least one wild card;
declaring any of the players a loser if the numerical value of the dealer cards is less than or equal to the predetermined maximum value and greater than the total numerical value of the player cards of the player with the primary wager being lost by the player;
declaring the round a push for any of the players if the numerical value of the dealer cards is equal to the numerical value of the player cards of the player with the primary wager not being lost and no prize awarded to the player;
declaring any of the players a winner if the numerical value of the player cards is less than or equal to the predetermined maximum value and greater than the total numerical value of the dealer cards with a value equal to the primary wager of the player being awarded to the player; and
forfeiting the primary wager of at least one of the players in response to the drawing of a wild card by another of the players.

2. A method of playing a blackjack game as set forth in claim 1 further including declaring each of the players a winner and awarding each of the players a value equal to the primary wager of the player in response to the dealer drawing the at least one wild card.

3. A method of playing a blackjack game as set forth in claim 1 further including allowing one of the players to be immediately awarded a value equal to the primary wager of the player in response to the drawing of a wild card by the player.

4. A method of playing a blackjack game as set forth in claim 1 wherein the at least one wild card is a joker card.

5. A method of playing a blackjack game as set forth in claim 1 wherein the predetermined maximum value is twenty one.

6. A method of playing a blackjack tournament including a plurality of players and a dealer, said method comprising:
playing a plurality of rounds of a blackjack game with each round of the blackjack game including the following steps:
providing a collection of playing cards consisting of at least one deck of playing cards each having a numerical value and a suit and a color, and wherein the collection of playing cards further includes at least one wild card;
providing a playing surface including a plurality of player positions wherein each of the player positions may receive a plurality of the cards, and at least one dealer position at which a plurality of the cards may be received for the dealer;
requiring each player to place a primary wager;
dealing two player cards to each player from the collection of playing cards in a manner so as to reveal the value of the player cards;
dealing a first dealer card and a second dealer card to the dealer in a manner so as to conceal the value of the first dealer card and reveal the value of the second dealer card;
separately allowing each player to request additional player cards from the collection of playing cards until the player achieves a desired numerical value of player cards less than or equal to a predetermined maximum value or until the player draws the at least one wild card;
declaring the player a loser if the numerical value of the player cards is greater than the predetermined maximum value with the wager being lost by the player;
revealing the value of the first dealer card;
drawing additional dealer cards from the collection of playing cards for the dealer until the numerical value of the dealer cards is less than or equal to the predetermined maximum value and greater than the total numerical value of the player cards of each of the players, or until the numerical value of the dealer cards exceeds the predetermined maximum value, or until the dealer draws the at least one wild card;
declaring any of the players a loser if the numerical value of the dealer cards is less than or equal to the predetermined maximum value and greater than the total numerical value of the player cards of the player with the primary wager being lost by the player;
declaring the round a push for any of the players if the numerical value of the dealer cards is equal to the numerical value of the player cards of the player with the wager not being lost and no prize awarded to the player;
declaring any of the players a winner if the numerical value of the player cards is less than or equal to the predetermined maximum value and greater than the total numerical value of the dealer cards with a value equal to the primary wager of the player being awarded to the player; and
either awarding a value equal to the primary wager of the drawing player or forfeiting the primary wager of another player separate from the drawings player in response to the drawing of the wild card by the drawing player.

7. A method of playing a blackjack tournament as set forth in claim 6 further including allowing each player to place a secret wager in a manner so as to conceal the value of the secret wager after a predetermined number of rounds of the blackjack game have been played; playing a final round of the blackjack game wherein the secret wager is utilized in place of the primary wager; and designating the player who has the largest sum of winnings after the final round a winner of the blackjack tournament.

8. A method of playing a blackjack game as set forth in claim 6 further including declaring each of the players a winner and awarding each of the players a value equal to the primary wager of the player in response to the dealer drawing the at least one wild card.

9. A method of playing a blackjack game as set forth in claim 6 wherein the at least one wild card is a joker card.

10. A method of playing a blackjack game as set forth in claim 6 wherein the predetermined maximum value is twenty one.

11. A method of playing a blackjack tournament including a plurality of players and a dealer, said method comprising:
playing a plurality of rounds of a blackjack game with each round of the blackjack game including the following steps:
providing a collection of playing cards consisting of at least one deck of playing cards each having a numerical value, a suit and a color;
the collection of playing cards further including at least one joker card;
shuffling the collection of playing cards;
requiring each player to place a primary wager;
dealing two player cards to each player from the collection of playing cards in a manner so as to reveal the value of the player cards;
dealing a first dealer card and a second dealer card to the dealer in a manner so as to conceal the value of the first dealer card and reveal the value of the second dealer card;
separately allowing each player to request additional player cards from the collection of playing cards until the player achieves a desired numerical value of player cards less than or equal to a value of twenty one or until the player draws the at least one joker card;
declaring the player a loser if the numerical value of the player cards is greater than a value of twenty one with the wager being lost by the player;
revealing the value of the first dealer card;
drawing additional dealer cards from the collection of playing cards for the dealer until the numerical value of the dealer cards is less than or equal to twenty one and greater than the total numerical value of the player cards of each of the players or until the numerical value of the dealer cards exceeds twenty one;
declaring any of the players a loser if the numerical value of the dealer cards is less than or equal to twenty one and greater than the total numerical value of the player cards of the player with the primary wager being lost by the declared losing player;
declaring the round a push for any of the players if the numerical value of the dealer cards is equal to the numerical value of the player cards of the player with the wager not being lost and no prize being awarded to the player;
declaring any of the players a winner if the numerical value of the player cards is less than or equal to twenty one and greater than the total numerical value of the dealer cards with a value equal to the primary wager of the player being awarded to the player;
either awarding a value equal to the primary wager of the drawing player or forfeiting the primary wager of a second player separate from the drawing player in response to the drawing of the wild card by the first player;
declaring each of the players a winner and awarding each of the players a value equal to the primary wager of each player in response to the dealer drawing a joker;
allowing each player to place a secret wager in a manner so as to conceal the value of the secret wager after a predetermined number of rounds of the blackjack game have been played;
playing a final round of the blackjack game using the secret wager in place of the primary wager;
designating the player who has the largest sum of winnings after the final round a winner of the blackjack tournament.
